(19) United States
(12) Patent Application Publication
(10) Pub. No.: US 2011/0198292 A1
(43) Pub. Date: Aug. 18, 2011

(54) DESALINATION OF WATER

(76) Inventors: Walter W. Scarborough, Houston, TX (US); Pepe Gonzales, Houston, TX (US); Wade Adams, Houston, TX (US); Scott Beck, Houston, TX (US)

(21) Appl. No.: 12/705,414

(22) Filed: Feb. 12, 2010

(51) Int. Cl. C02F 1/42

(52) U.S. Cl. 210/663; 210/685; 210/502.1; 210/294

(57) ABSTRACT

A method and apparatus is provided for use in desalinating water. A desalination processes uses a polymer material to bind sodium (Na) and chlorine (Cl) ions in salt water. Once the polymer binds to the sodium and chlorine ions, they can be separated from the water. Once separated from the water, the sodium and chlorine molecules can be separated from the polymer, and the polymer reused in subsequent desalination cycles.

### FIELD

This invention relates to the field of water desalination. In particular, this invention is drawn to desalination of water using a polymer material.

### BACKGROUND

Desalination refers to any of several processes that remove salt and other minerals from water. In some examples, sea water (or salt water from another source) is desalinated for use as fresh water suitable for human consumption or irrigation. In other examples, salt water is an undesirable by-product of industrial processes, and must be treated to reduce the salt concentration. However, common desalination techniques typically require large amounts of energy, and are not cost-effective.

### SUMMARY

A method is provided for the desalination of salt water, the method including ionizing a non-water-soluble polymer to provide binding points for Na+ and Cl− ions, exposing the polymer to a saline water solution to facilitate the binding of Na+ and Cl− ions from the saline water solution to the polymer, separating the polymer from the saline solution, and separating the polymer from the Na and Cl.

Another embodiment provides a method for the desalination of salt water, the method including using a non-water-soluble polymer to provide binding points for Na+ and Cl− ions, exposing the polymer to a saline water solution to facilitate the binding of Na+ and Cl− ions from the saline water solution to the polymer to form a mass having a relative density greater than water, and using a centrifuge to separate the formed mass from the solution.

Another embodiment provides an apparatus for desalinating salt water including an ionizer for ionizing a non-water-soluble polymer material to provide binding points for Na+ and Cl− ions, a vessel configured to hold a saline water solution and configured to expose the ionized polymer material to the saline water solution, and a separator for separating the polymer material from the water.

Other features and advantages will be apparent from the accompanying drawings and from the detailed description that follows below.

### BRIEF DESCRIPTION OF THE DRAWINGS

The present disclosure is illustrated by way of example and not limitation in the figures of the accompanying drawings, in which like references indicate similar elements and in which:

FIG. 1 is a functional block diagram illustrating one example of system that may be used for water desalination.

FIG. 2 is a flowchart illustrating one example of a process for desalinating water using the system shown in FIG. 1.

FIG. 3 is a functional block diagram illustrating another example of a system that may be used for water desalination.

### DETAILED DESCRIPTION

This disclosure relates to the desalination of water and other related technologies. A desalination process described herein may be used for any desired application. For example, water desalination may be used to convert seawater to fresh water for human consumption or irrigation. In another example, desalination may be used to deal with salt water that is a byproduct of an industrial process, such as hydrocarbon exploration. The processes described below may also be used to remove other impurities from water. For example, the processes described below may be used to remove dissolved gases (e.g., HS, CO₂, etc.) and other toxic impurities (e.g., boron, heavy metals such as Arsenic or Mercury, etc.) from water.

Generally, the desalination processes described below utilize a polymer material to bind the sodium (Na) and chlorine (Cl) atoms from salt (NaCl) molecules in a saline water solution. Once the polymer binds to sodium and chlorine ions, a mass is formed with enough differentiation from the mass of the water to allow its separation from the water. Once separated from the water, the sodium and chlorine molecules are separated from the polymer, and the polymer is reused in subsequent desalination cycles. This process may be useful for removing other salts, as well.

Each atom of a salt molecule carries an electrical charge, one positive and one negative. When a salt molecule dissolves in water, the Na+ and Cl− ions are attracted to the bipolar H₂O molecules. However, the Na and Cl atoms do not make a bond with the H₂O that is so strong that the Na and Cl atoms cannot get back together if the H₂O evaporates. The desalination techniques described herein make use of a bipolar-ionized, non-water-soluble polymer. The bipolar polymer will attract both the Na+ and Cl− ions, which are oppositely charged, away from their weak bond with the H₂O, Note that, since dissolved gases, such as CO₂, behave similarly to Na and Cl, the ionized polymers may also lure these impurities away from the water molecules. Therefore, the techniques described herein may also be used to remove other impurities from water, besides salt.

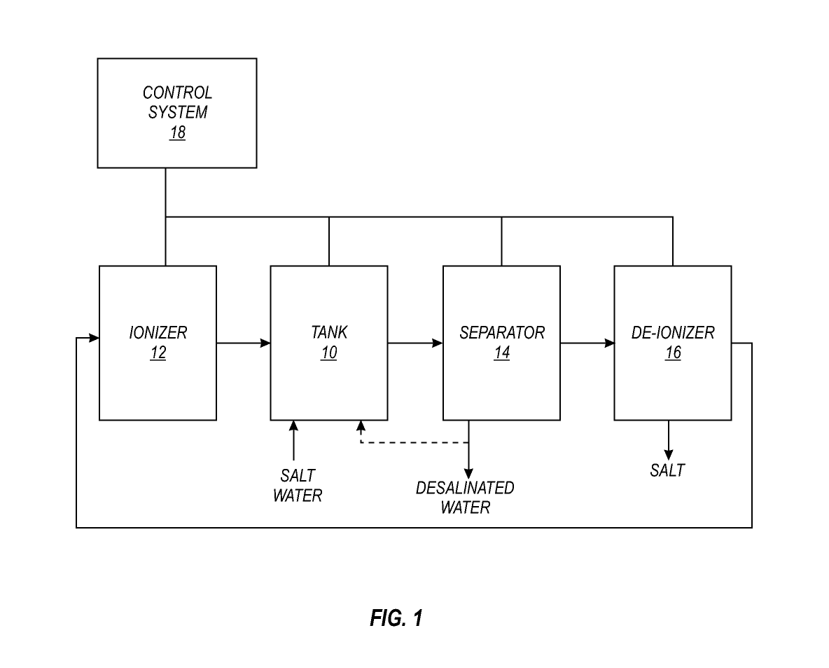

FIG. 1 is a functional block diagram illustrating one example of a system that may be used for water desalination. Note that the techniques described herein may also be implemented in any other desired manner. FIG. 1 shows a tank 10 that is configured to contain the salt water solution to be desalinated. The tank 10 may take any desired form, such as an enclosed tank, an open tank, a trough, a pool or pond, or any other type of containing vessel. As mentioned above, the process utilizes a bipolar-ionized non-water-soluble polymer. In one example, the polymer is ionized by ionizer 12, and exposed to a salt water solution in the tank 10. The polymer may take any desired physical form, such as a powder-like material, a shredded material, pellets, a porous or spongy material, a structured shape, etc. If desired, the polymer material may also be provided as a coating on another host material, or as a mixture with another material. In some examples, it may be desirable to maximize the surface area of the polymer to maximize its effectiveness.

Once the polymer is exposed to the salt water solution in the tank 10, the Na+ and Cl− ions will be attracted to and bind with binding points formed on the polymer. If desired, the effectiveness of the process may be enhanced by agitating or stirring polymer and the saltwater solution. With some polymers, the polymers may tend to coagulate in the water, and agitation may insure that the NaCl and other ionized pollutants are exposed to the polymer material.

Once the Na+ and Cl− ions have a bond to the polymer, the polymer and attached molecules will form a mass of material that will have a relative density greater than water, allowing the mass of material to be separated from the water. In the example shown in FIG. 1, a separator 14 separates the mass from the water. In one example, the separator 14 may include a centrifugal pump. The centrifugal forces in the pump will tend to separate the water from the heavier, alien mass, formed by the polymer material loaded by the salt, dissolved gases, and heavy metals. The alien mass will be sufficiently heavier than the specific gravity of the surrounding water so that the centrifugal pump can separate the water and the impurities. In another example, a filtration system can be used to filter the alien mass from the water. The separated (desalinated) water can be removed from the separator 14, or cycled back to the tank 10 if a higher level of purity is desired.

FIG. 1 also shows a deionizer 16. The deionizer 16 is used to deionize the mass formed by the polymers and impurities, so that the polymers can be separated from the salts, dissolved gases, and heavy metals. Once the polymer material is separated, the polymer material can be re-ionized by ionizer 12, and reused in subsequent desalination cycles. The impurities (e.g., salt) can be removed from the de-ionizer 16 and disposed or recycled.

Depending on the effectiveness of the desalination process described above, and depending on the desired purity of the desalinated water, the water can be subjected to multiple desalination cycles until a desired purity is obtained. In one example, the water is cycled through the same apparatus multiple times until the desired purity is obtained. In another example, multiple desalination devices (such as that shown in FIG. 1) can be configured in series to obtain the desired purity. In another example, a combination of multiple desalination devices and a re-cycling process may be used.

A desalination system can be controlled in any desired manner. FIG. 1 shows a control system 18 coupled to the tank 10, ionizer 12, separator 14, and di-ionizer 16. In some examples, the control system 18 may be a computer based control system, a manual control system, or some combination thereof. The control system 18 may use a number of sensors to affect the control of the system. For example, the control system 18 may use temperature sensors, pressure sensors, salinity sensors (e.g., conductivity sensors), flow sensors, turbidity sensors, and other types to control the system. The control system 18 may used to precisely control a desalination process such that water is desalinated until such time that the water reaches a desired purity. In one example, the control system 18 controls items such as ionization and de-ionization intensities and durations, polymer exposure durations, polymer concentration levels, agitation intensities and durations, separation times, temperature and pressure levels, etc., based on predetermined programming, user inputs, and/or information from the sensors. In one example, the control system 18 may be programmed to cycle through a desalination process until the water reaches a purity level of X parts per million (ppm).

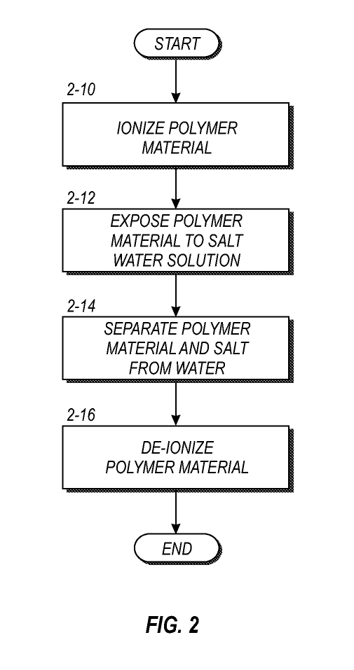

FIG. 2 is a flowchart illustrating one example of a process for desalinating water using the apparatus described above. The process begins at step 2-10 were the polymer material is ionized. As described above, in one example, the polymer is a bipolar-ionized non-water-soluble polymer, which provides binding points for Na+ and Cl− ions. At step 2-12, the ionized polymer is exposed to the saltwater solution. If desired, the saltwater solution and polymer mixture is agitated or stirred to maximize the binding of the ions to the polymer. Next, at step 2-14, the mass formed by the polymer and the salt molecules (as well as any other dissolved gases or heavy metals) is separated from the water. In one example, a centrifugal pump is used to separate the mass from the water. Once separated, at step 2-16, the mass is de-ionized to separate the polymer material from the impurities so that the polymer material reused at step 2-10 in subsequent desalination cycles. If desired, the process illustrated in FIG. 2 can be repeated (using the same equipment or additional equipment in series) until a desired water purity is obtained.

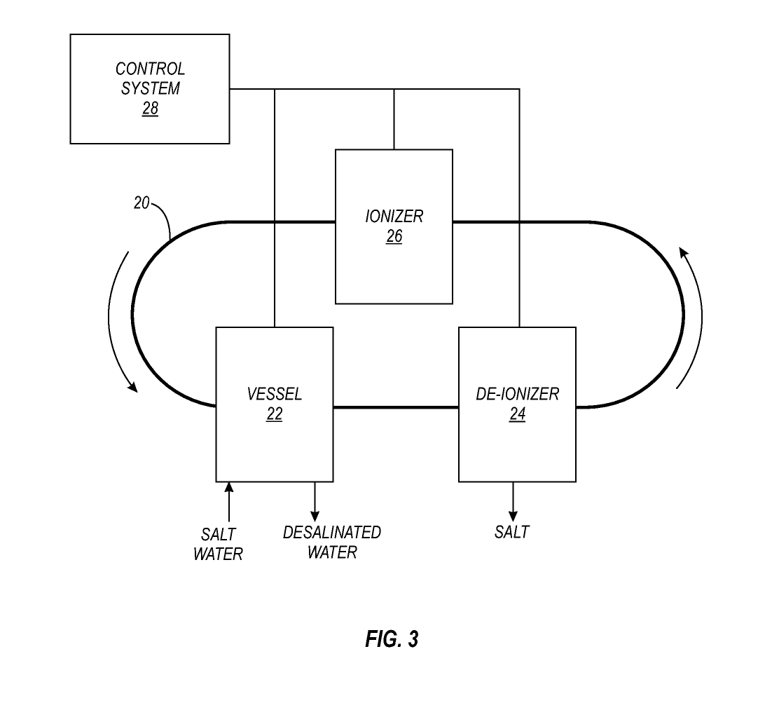

FIG. 3 is a functional block diagram illustrating another example of an apparatus that may be used in a water desalination process. Note that FIG. 3 is intended to illustrate the function of an exemplary continuous water desalination process, and is not intended to depict the physical appearance of a desalination device. Generally, in this example, a polymer material, similar to that described above, forms a suitable shape or shapes (a belt, film, etc.) to form a conveyor belt, or similar system, for a continuous operation. In this example, the polymer material moves through various areas, each forming one phase of a desalination process.

FIG. 3 shows a continuous conveyor belt 20 formed using the polymer material. In one example, the polymer material forming the conveyor belt 20 takes the form of a sponge-like structure, to maximize its surface area. If desired, the conveyor belt 20 can be reinforced by another material for strength and durability. The conveyor belt 20 is moved through various phases in the direction shown by the arrows. At a first phase, the polymer conveyor belt 20 is exposed to saltwater contained in the vessel 22. As described above, once the polymer is exposed to the saltwater solution in the vessel 22, the Na+ and Cl− ions, other dissolved gases, and heavy metals, will be attracted to and bind with binding points formed in the polymer. If desired, the effectiveness of the process may be enhanced by agitating the conveyor belt 20 and/or the water contained in the vessel 22. The speed of the conveyor belt 20 can be chosen to obtain a desired efficiency of the system, as one skilled in the art would understand.

As the polymer conveyor belt 20 exits the vessel 22, it will enter the next phase. A deionizer 24 is used to deionize the polymer conveyor belt 20, which includes the bound particles, to separate the salts, dissolved gases, and heavy metals, from the polymer. The separated impurities can be collected and disposed or recycled. As the polymer conveyor belt 20 exits the deionizer 24, it will enter the next phase, where ionizer 26 re-ionizes the polymer conveyor belt, so the desalination cycle can be repeated. In the example illustrated in FIG. 3, the process continues until the desired purity level is obtained. Also note that numerous other configurations are also possible. For example, the system could use multiple conveyor belts to shorten the time required to desalinate the water, and/or increase the efficiency of the system.

The desalination system shown in FIG. 3 can be controlled in any desired manner. FIG. 3 shows a control system 28 coupled to the vessel 22, de-ionizer 24, and ionizer 26. In some examples, the control system 28 may be a computer based control system, a manual control system, or some combination thereof. The control system 28 may use a number of sensors to affect the control of the system. For example, the control system 28 may use temperature sensors, pressure sensors, salinity sensors, flow sensors, turbidity sensors, and other types to control the system. The control system 28 may used to precisely control the desalination process such that the conveyor 20 is run through the system until the water reaches a desired purity. In one example, the control system 28 controls items such as conveyor speed, ionization and de-ionization intensities, agitation intensities and durations, temperature and pressure levels, etc., based on predetermined programming, user inputs, and/or information from the sensors.

In the preceding detailed description, the disclosure is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method for the desalination of salt water, the method comprising:
ionizing a non-water-soluble polymer to provide binding points for Na+ and Cl− ions;
exposing the polymer to a saline water solution to facilitate the binding of Na+ and Cl− ions from the saline water solution to the polymer;
separating the polymer from the saline solution; and
separating the polymer from the Na and Cl.

2. The method of claim 1, further comprising de-ionizing the polymer to separate the polymer from the Na and Cl.

3. The method of claim 1, further comprising re-ionizing the polymer after the Na and Cl are separated from the polymer for use in subsequent cycles.

4. The method of claim 1, further comprising using a centrifuge to separate the polymer from the saline solution.

5. The method of claim 1, further comprising using a filtration system to separate the polymer from the saline solution.

6. The method of claim 1, further comprising agitating the saline water solution after exposing the polymer to the saline water solution.

7. The method of claim 1, further comprising using the polymer to form a conveyor that moves through an ionizer, the saline water solution, and a de-ionizer.

8. A method for the desalination of salt water, the method comprising:
using a non-water-soluble polymer to provide binding points for Na+ and Cl− ions;
exposing the polymer to a saline water solution to facilitate the binding of Na+ and Cl− ions from the saline water solution to the polymer to form a mass having a relative density greater than water; and
using a centrifuge to separate the formed mass from the solution.

9. The method of claim 8, further comprising ionizing the polymer prior to exposing the polymer to the saline water solution.

10. The method of claim 8, further comprising separating the polymer from the Na and Cl.

11. The method of claim 10, further comprising de-ionizing the polymer to separate the polymer from the Na and Cl.

12. The method of claim 10, further comprising ionizing the separated polymer for use in subsequent desalination cycles.

13. The method of claim 8, further comprising agitating the saline water solution after exposing the polymer to the saline water solution.

14. The method of claim 8, further comprising using the polymer to form a conveyor that moves through an ionizer, the saline water solution, and a de-ionizer.

15. An apparatus for desalinating salt water comprising:
an ionizer for ionizing a non-water-soluble polymer material to provide binding points for Na+ and Cl− ions;
a vessel configured to hold a saline water solution and configured to expose the ionized polymer material to the saline water solution; and
a separator for separating the polymer material from the water.

16. The apparatus of claim 15, further comprising a de-ionizer for de-ionizing the polymer material to separate the Na and Cl from the polymer.

17. The apparatus of claim 16, wherein the ionizer is configured to re-ionize the polymer after the Na and Cl are separated from the polymer for use in subsequent cycles.

18. The apparatus of claim 15, wherein the separator further comprises a centrifuge.

19. The apparatus of claim 15, further comprising an agitator for agitating the saline water solution and polymer.

20. The apparatus of claim 15, further comprising a conveyor belt comprised of the polymer material, wherein the conveyor belt is configured to move through an ionizer, the vessel, and a the separator.
